(19) United States
(12) Patent Application Publication
(10) Pub. No.: US 2015/0053696 A1
(43) Pub. Date: Feb. 26, 2015

(54) COOKING UTENSIL WITH A PINCH AND CATCH DETACHABLE HANDLE

(71) Applicant: Charcoal Companion Incorporated, Berkeley, CA (US)

(72) Inventors: Cory Thomas Borovicka, Oakland, CA (US); Jane Rabanal, Oakland, CA (US)

(21) Appl. No.: 14/466,886

(22) Filed: Aug. 22, 2014

Related U.S. Application Data
(60) Provisional application No. 61/869,723, filed on Aug. 25, 2013.

(51) Int. Cl. A47J 45/07

(52) U.S. Cl. CPC A47J 45/072
USPC 220/573.1

(57) ABSTRACT

A cooking utensil is has a food container for holding food items, a catch mechanism on the outside of the food container at or near the rim of the food container. A handle is provided which has opposed side rods having opposed free ends and oppositely extending catch legs which form an attachment end of the handle. The opposed free ends of the opposed side rods have a normal at rest separation and are capable of being flexed inwardly towards each other from their normal separation by a pinching force applied by hand to the side rods so that they can be inserted into and be disengaged from the catch mechanism on the food container.

### CROSS-REFERENCE TO RELATED APPLICATIONS

This application claims the benefit of U.S. Provisional Patent Application No. 61/869,723, filed Aug. 22, 2013, which is incorporated herein by reference.

### BACKGROUND

The present invention relates to cooking utensils and more particularly cooking utensils having detachable handles.

The use of detachable handles on cooking utensils such as pots and pans is well known. However, the attachment mechanisms used for such handles are often bulky, relatively costly to manufacture and cumbersome to use. The present invention provides a cooking utensil with a detachable handle and attachment mechanism that can be manufactured relatively inexpensively and that can easily be operated. When engaged, the detachable handle provides secure attachment to the body of the utensil without the risk of becoming unintentionally dislodged or repositioned while the utensil is being held, moved or shaken. The attachment mechanism is particularly well adapted for use with woks, which have thin-walled bowls for holding food items to be cooked, but could be used with other types of food holding containers and containers of various shapes.

### SUMMARY OF INVENTION

The invention is directed to a cooking utensil which is comprised of a food container for holding food items and a catch mechanism on the outside of the side portion of the food container portion at or near the rim portion of the food container. A handle is provided which is comprised of opposed side rods having opposed free ends and oppositely extending catch legs at its free ends. The opposed free ends of the opposed side rods have a normal at rest separation and are capable of being flexed inwardly towards each other from their normal separation by a pinching force applied by hand to the side rods. The oppositely extending catch legs at the free ends of the handle side rods can be inserted into and disengaged from the catch mechanism on the food container side portion when the free ends of the opposed side rods are pinched inwardly by hand. The catch legs can engage the catch mechanism when the free ends of the handle side bars are released and allowed to return to their normal separation. The catch mechanism on the food container can be in the form of a catch loop, and the length of the catch loop can be approximately the same as the at rest separation of the side rods of the handle.

In a further aspect of the invention, a stop member is provided on the outside of the side portion of the food container below the catch mechanism to prevent the free ends of the side rods from traveling substantially further past the catch mechanism on the food container once the oppositely extending catch legs at the free ends of the handle side rods are engaged with the catch mechanism.

In still another aspect of the invention, an open relief slot can be provided in the rim of the food container at the location of the catch mechanism. This open relief slot can be sized so that the handle can pivot into a stowed position within the food container when the oppositely extending catch legs at the free ends of the handle side rods are engaged in the catch mechanism of the food container.

### BRIEF DESCRIPTION OF THE DRAWINGS

FIG. 1 is bottom perspective view of a wok having a detachable handle in accordance with the invention.

FIG. 2A is a top plan fragmentary view thereof showing the detachable handle removed from the bowl portion of the wok and an initial gripped position of a hand on the handle preparatory to attaching the handle to the wok.

FIG. 2B is another top plan fragmentary view thereof showing a first step in attaching the gripped detachable handle to the attachment mechanism of the bowl portion of the wok.

FIG. 2C is a further top plan fragmentary view thereof showing a second step in attaching the gripped detachable handle to the attachment mechanism of the bowl portion of the wok.

FIG. 2D is still another top plan fragmentary view thereof showing a third step in attaching the gripped detachable handle to the attachment mechanism of the bowl portion of the wok.

FIG. 2E is still a further top plan fragmentary view thereof showing a fourth step in attaching the gripped detachable handle to the attachment mechanism of the bowl portion of the wok.

FIG. 2F is yet another top plan fragmentary view thereof showing the detachable handle fully engaged in the attachment mechanism of the bowl portion of the wok.

FIG. 3A is a bottom perspective fragmentary view of the wok shown in FIG. 1 showing in more detail the stop member added to the attachment mechanism of the bowl portion of the wok, and showing the attachment end of a detachable handle disengaged from the bowl's attachment mechanism.

FIG. 3B is a bottom perspective fragmentary view thereof taken along lines 3B-3B of FIG. 1 showing the detachable handle engaged in the bowl's attachment mechanism.

FIG. 4A is a fragmentary side elevational view of the wok shown in FIG. 1 showing in more detail the structure of the attachment mechanism of the bowl portion of the wok and the attachment end of the detachable handle of the wok engaged therein.

FIG. 4B is a cross-sectional view thereof taken along lines FIG. 4B-4B in FIG. 2F.

FIGS. 5A-5F show how the detachable handle of the wok can be folded back into the bowl of the wok for storage or shipment.

### DESCRIPTION OF ILLUSTRATED EMBODIMENT

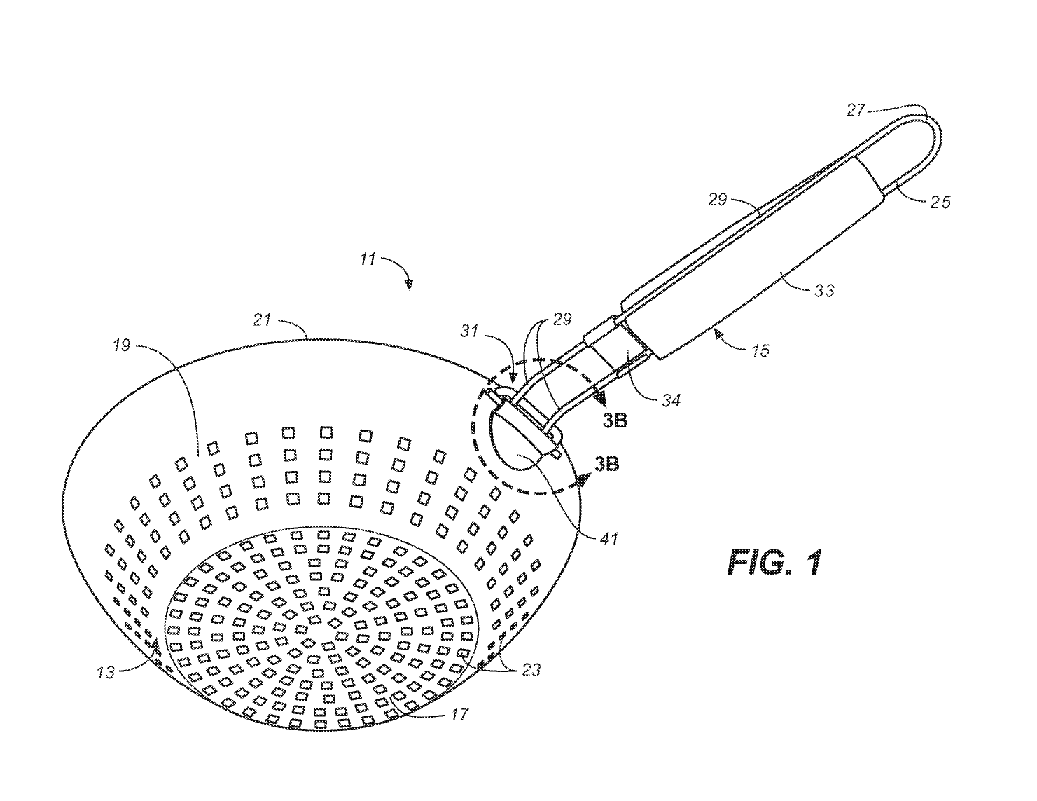

Referring now to the drawings, FIG. 1 shows a cooking utensil comprised of a food container in the form of a wok 11 having a bowl 13 and detachable handle 15. The bowl portion of the wok includes a perforated bottom 17, a side portion in the form of outwardly flared thin side walls 19, and a top rim portion 21. The perforations 23 in the bottom of the wok suitably extend part way up into the wok's lower side walls, leaving the top rim portion of the sidewalls unperforated. The perforated bowl of the wok is suitably fabricated from a thin sheet stainless steel using a stamping or other inexpensive manufacturing process.

The detachable handle 15 has a rod construction, which like bowl 13 can be manufactured relatively inexpensively. In the illustrated embodiment, the rod component of the handle is formed from a single rod 25, suitably a stainless steel rod, bent in an elongated U-shape to form an elongated handle structure having a distal end 27 and elongated opposed side rods 29 which terminate at opposed free ends 31. A gripping block 33, suitably made of plastic or wood, can be inserted between the opposed side rods of the handle to provide larger gripping structure for the user. The gripping block suitably extends over substantial portion of the handle, but terminates well short of the free ends of side rods 29. The opposed side rods 29 will have enough flexibility that the free ends of the rods will flex inwardly toward each other when the side rods are pinched together below the insert 33 as hereinafter described.

At the free ends of the side rods, the side rods are bent outwardly away from each other to provide short, oppositely extending catch legs 35a and 35b. Oppositely extending catch legs at the free ends of the side rods could be provided by means other than bending the ends of the side rods, such as by welding or otherwise attaching oppositely extending parts to the ends of the bent rod. However, bending the ends of the U-shaped rod outwardly provide an inexpensive way of providing the attachment elements needed at the attachment end of the handle.

As hereinafter described, the catch legs at the free ends of the handle's side rods provide a structure capable of being inserted into and “catching” the also hereinafter described catch mechanism on the bowl of the wok. And once the free ends of the handle's side rods are engaged with the wok's catch mechanism, the handle can be locked in place by slide lock 34, which is attached across the handle's opposed side rods 29 below the handle insert. The manner of locking the handle in place is described in more detail below.

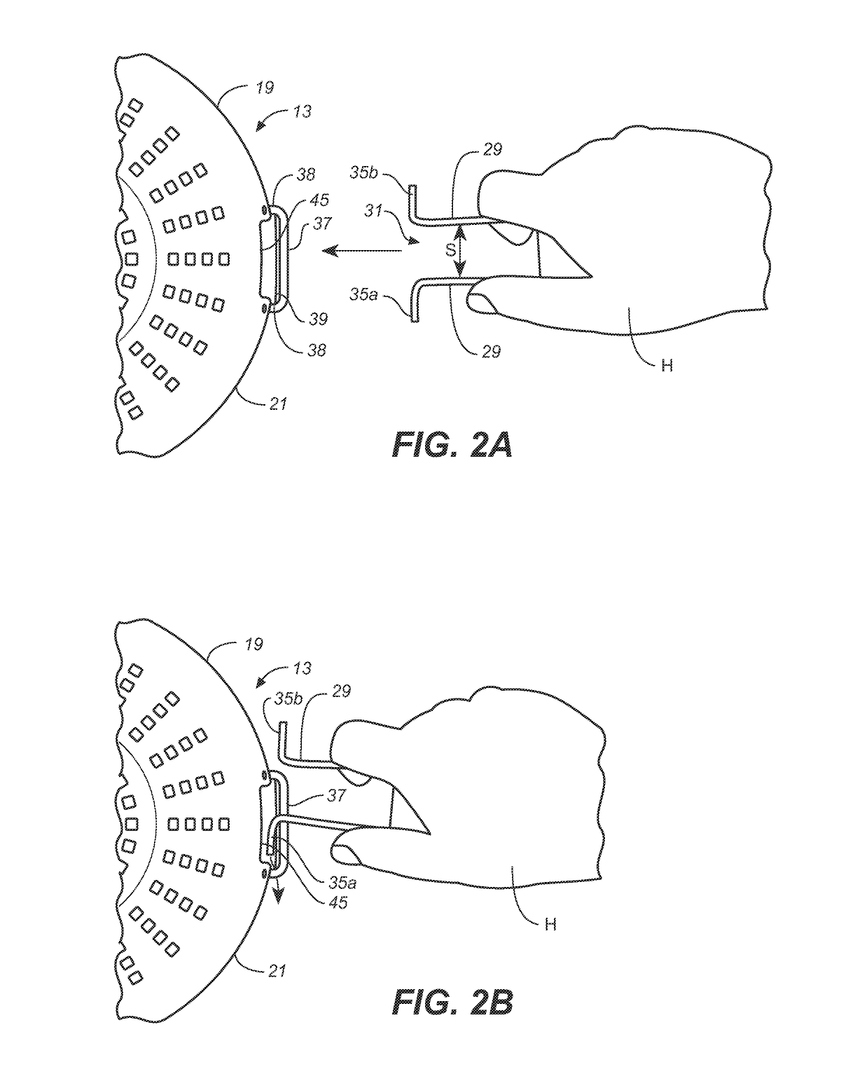

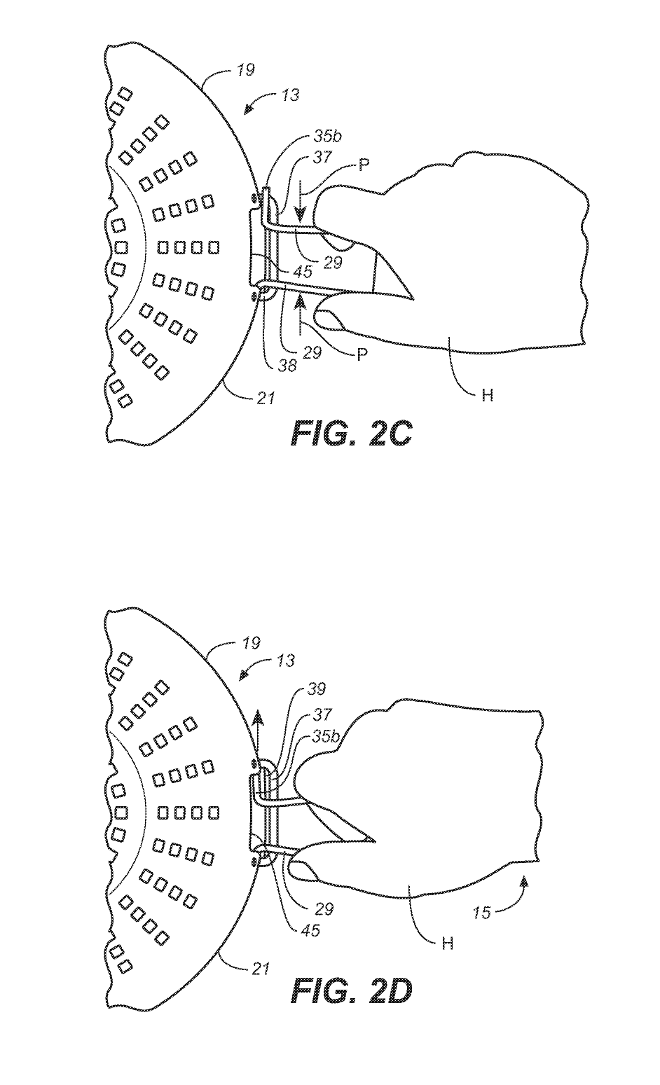

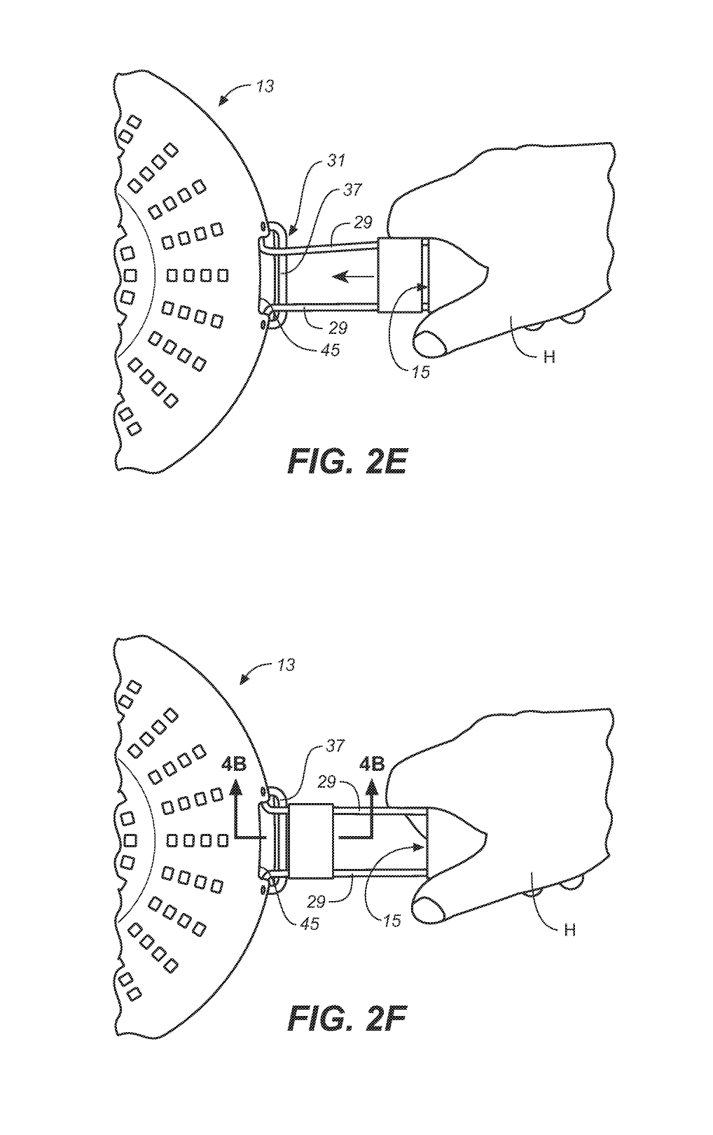

The rod-based handle 15 is attached and detached from the bowl 13 of the wok via a simply constructed catch mechanism that will catch and hold the free ends of the opposed side rods of the handle when the side rods are pinched and released during an inserting motion. The catch mechanism can be comprised of a catch loop 37, which is preferably a metal loop attached, such as by spot welding, to the outside 20 of the bowl's sidewall 19 just below the rim 21 of the bowl. The length of the catch loop is chosen to approximately correspond to the separation (denoted by the letter “S” in FIG. 2A) of the unflexed free ends of the handle's side rods 29, so as to allow the free ends of the side rods to engage or “catch” the edge portions 38 of the catch loop when inserted into the loop.

While the catch loop is preferably a closed loop, as shown in the drawings, it is contemplated that the catch loop could be a partially open loop formed by two pieces of rod bent inwardly toward each other to provide suitable edge structures for catching the free ends of the handle. It is further contemplated that the catch loop can be formed by a piece of bent rod, suitably from the same metal rod stock used to form the bent rod component of the wok's handle.

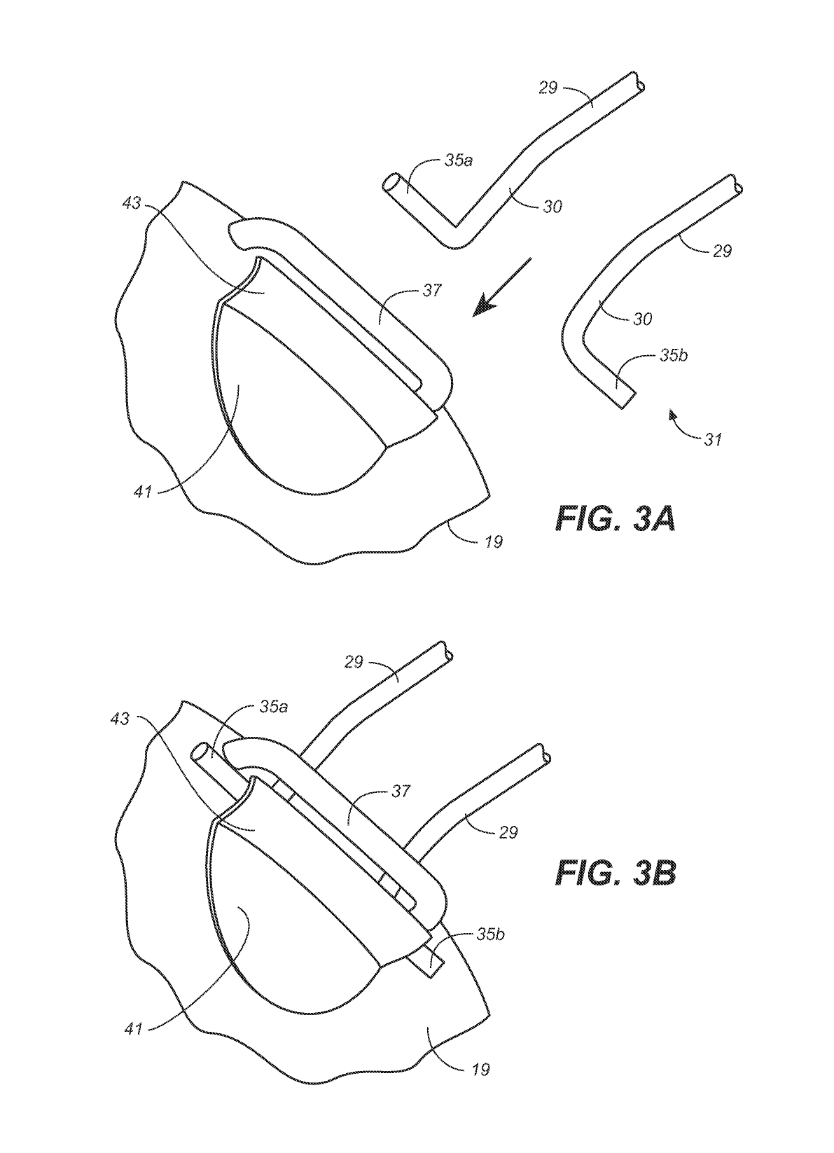

A stop member in the form of stop bracket 41 can be secured to the outside sidewall of the bowl immediately below the catch loop. This stop member will prevent the attachment end of the handle from traveling past the catch loop when engaged in the loop, keeping the handle in a fixed stable position on the bowl when attached. As best illustrated in FIGS. 3A and 3B, the stop bracket can be in the form of a plate having an outwardly bent top saddle portion 43 formed to cradle the laterally extending catch legs at the free ends of the handle's side rods when the free ends of the handle's side rods are inserted through the catch loop. The stop member can be a single bracket as shown or two or more parts that provide a stop for the free ends of the handle side rods. It is suitably a metal part spot-welded to the sidewall of the bowl.

FIGS. 2A-2F illustrate the steps of attaching handle 15 to the above-described attachment mechanism provided on bowl 15. As shown in FIG. 2A, the handle is gripped by the hand H near the attachment end of the handle and then one of the laterally extending catch legs is inserted into catch loop 37 as shown in FIG. 2B, which shows catch leg 35a being inserted into the catch loop after the attachment end of the handle is positioned over the top of the loop. As denoted by pinch arrows P in FIG. 2C, the free ends of the handle side rods 29 are then pinched inwardly toward each other until the other catch leg 35b is able to pass through the catch loop opening 39 as shown in FIG. 2D. The pincher force being exerted on the handle side rods can then be released to allow the free ends 31 of the handle to engage in the catch loop as shown in FIG. 2E. Thereafter, the stop bracket 41 will prevent any downward force exerted on the handle (represented by the longitudinally directed arrow in FIG. 2E) from pushing the handle further through the catch loop. Once engaged, the bowl can be picked up by the handle as shown in FIG. 2F. When picked up, the weight of the wok 13 will cause the wok to pivot about the catch legs until the catch loop on the wok hits the bottom of the attachment end of the handle, whereupon the handle and wok will be locked together by the gravity forces on the wok.

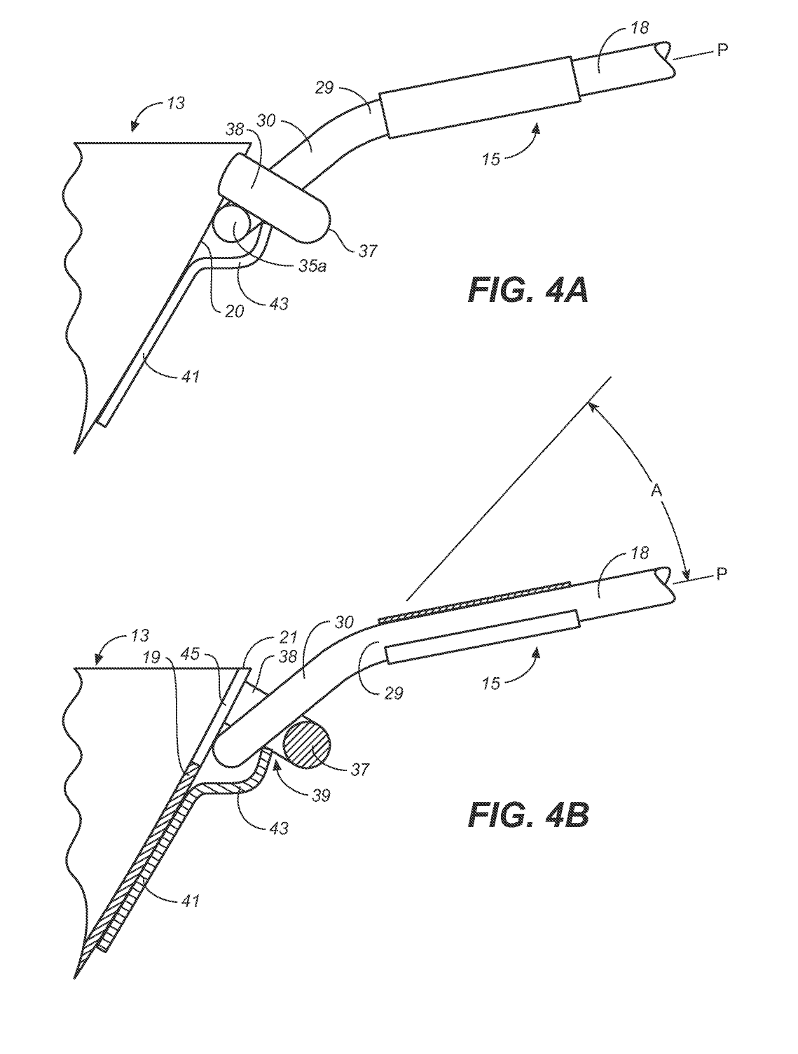

As best shown in FIGS. 4A and 4B, when picked up, the laterally extending catch legs 35a and 35b at the ends of the handle side rods 29 engage under the edge portions 38 of the catch loop so that the handle will not pull out of the catch loop. Conversely, when the wok is set back down, the saddle portion 43 of the stop bracket beneath the catch loop will prevent the attachment end of the handle from falling down through the catch loop. As best seen in FIGS. 4A and 4B, the end portion 30 of the handle's opposed side rods above catch legs 35a, 35b can be bent down at an angle A relative to the plane P of the straight extended portions 18 of the handle's side rods to alter the pitch of the handle relative to the bowl when the handle is deployed in an extended gripping position as shown in FIG. 1. Suitably, the angle A (shown in FIG. 4B) relative to plane P can be about 30 degrees. The bent ends cause a decrease in the pitch angle of the handle to increase ease of handling.

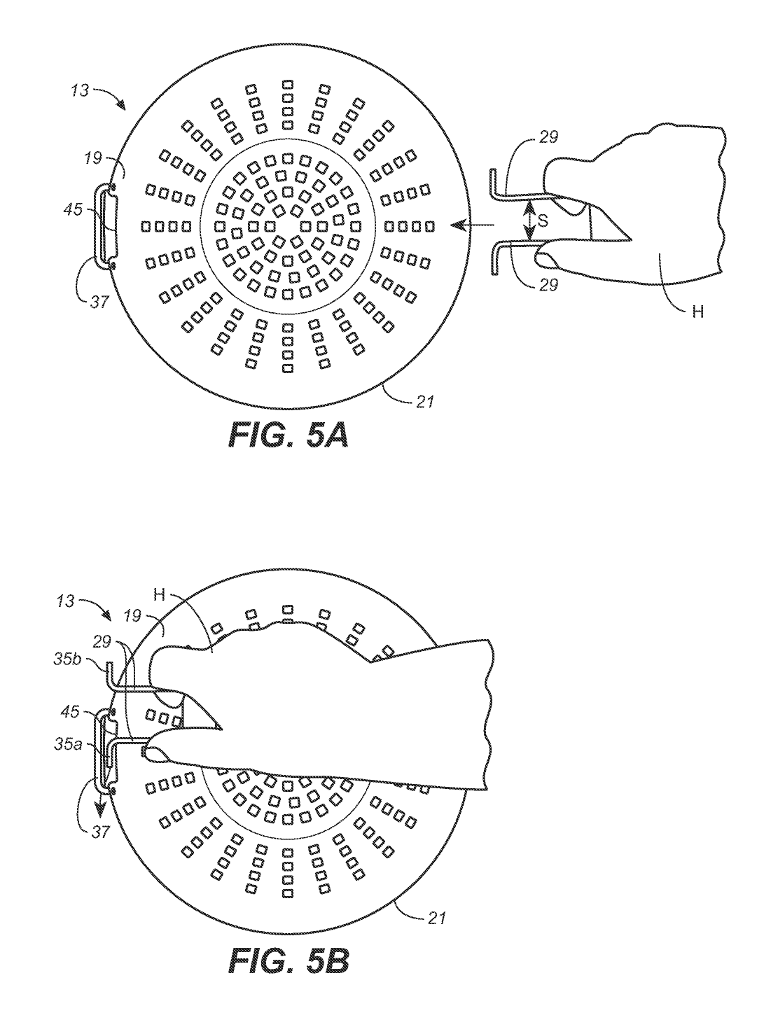

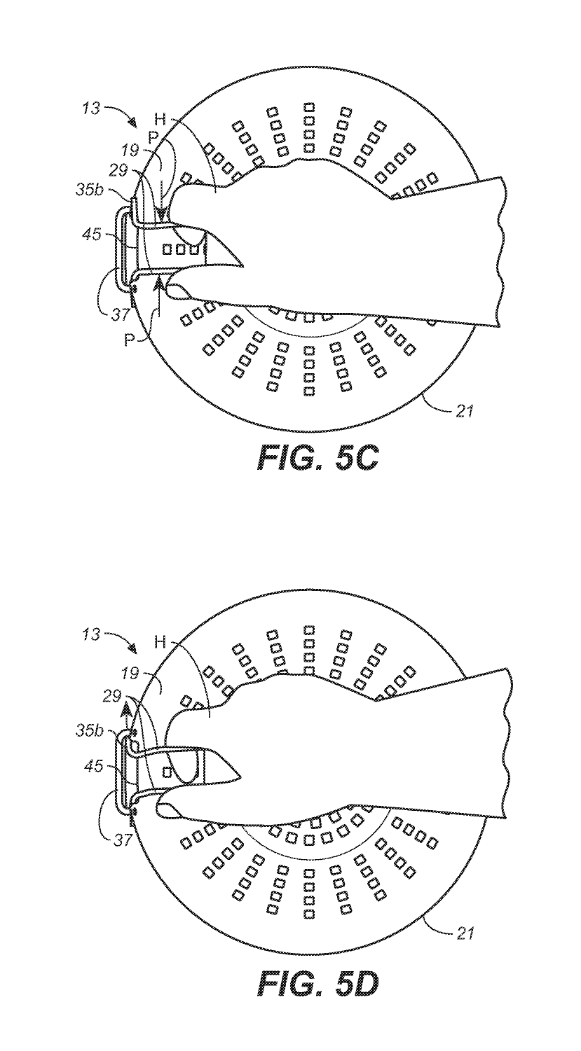

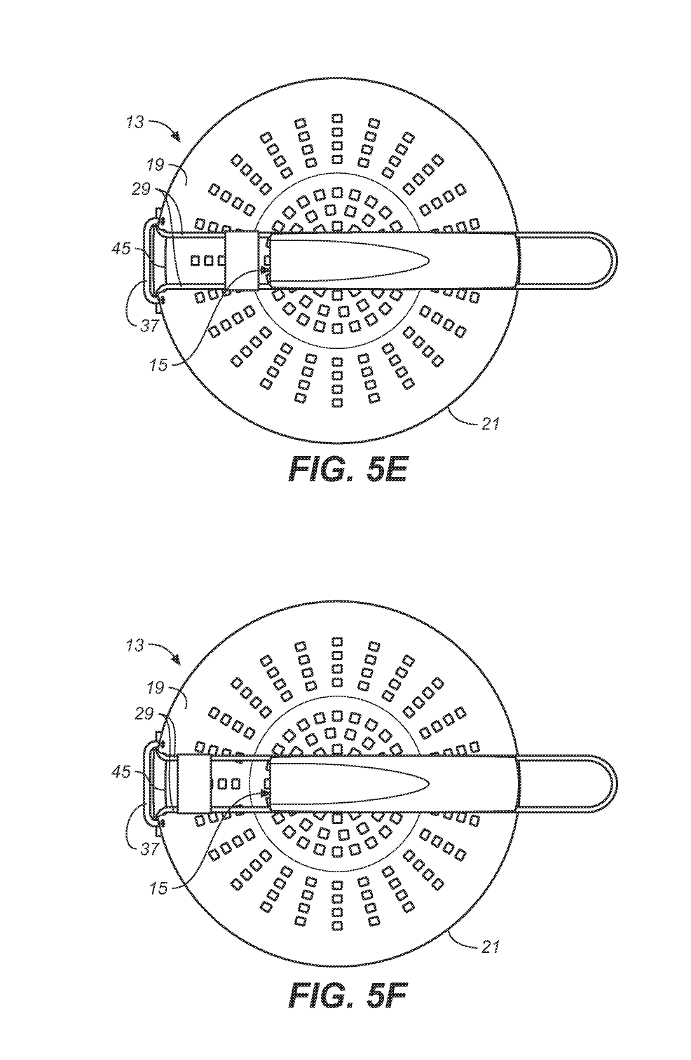

Referring to FIGS. 5A-5F, it is seen that an open relief slot 45 provided in the rim 21 of the bowl of the wok at the location of the catch loop will allow the handle to be pivoted back over the bowl while it is engaged in the catch loop. The width of this relief slot substantially spans the extent of the catch loop 37 and is most suitably slightly smaller than the length of the catch loop. By making the relief slot slightly smaller than the length of catch loop, the ends of the catch loop can be attached to the rim of the wok at the top of the wok's sidewalls 19 just outside of the ends of the relief slot, while providing a sufficient relief space for the folding back handle.

Due to the presence of the relief slot, the handle can be stowed over the bowl as shown in FIG. 5F with the handle engaged to the bowl, such as when the wok is stored or shipped. Also, the bent ends 30 of the handle's opposed side rods, which pitch the handle down when the handle is in its extended position, will facilitate stowing of the handle. By reversing the handle on the catch loop (see FIGS. 5A-5C), the bent ends allow the attachment end of the clear the top edge of the relief slot on the edge of the bowl when handle is pivoted back over the bowl, thus allowing the handle to lie flat across the top of the bowl.

It will be appreciated that instead of the illustrated single continuous relief slot 45, separate smaller relief slots could be provided near the ends of the catch loop. The separate relief slots would need to be wide enough to accommodate opposed side rods 29 as the handle pivots to a stowed position. However, a single relief slot will eliminate the additional and potentially sharp corners created by separate slots.

It is contemplated that an attachment mechanism for the bowl of the wok as above described can be provided on different sized bowls such that any one of the bowls can be engaged and picked up by the same handle. The attachment and detachment of the handle from any one of the bowls can easily and reliably accomplished by the pinching and release steps described above. Thus, an entire set of bowls, suitably nested bowls for ease of shipment and storage, can be supplied with a single pick-up handle.

As earlier noted, it will be appreciated that the detachable handle and attachment mechanism of the illustrated and above-described wok can be used with cooking utensils other than woks, so long as the food holding container portion of the utensil has a side wall or frame to which the above-described attachment mechanism can be affixed. This would include round or square pots and pans and cooking baskets having wire frames.

While one embodiment of the invention has been described in considerable detail in the foregoing specification, it will be understood that it is not intended that the invention be limited to such detail, except as necessitated by the following claims.

We claim:

1. A cooking utensil comprising
a food container for holding food items, said food container having a side portion and a top rim portion, and said side portion having an outside,
a catch mechanism on the outside of the side portion of said food container portion at or near the rim portion thereof, and
a handle comprising opposed side rods having opposed free ends and oppositely extending catch legs at the free ends of said side rods wherein said free ends and catch legs form an attachment end of the handle, the opposed free ends of the opposed side rods having a normal at rest separation and being capable of being flexed inwardly towards each other from their normal separation by a pinching force applied by hand to the side rods, wherein the oppositely extending catch legs at the free ends of the handle side rods can be inserted into and be disengaged from the catch mechanism on said food container side portion when the free ends of the opposed side rods are pinched inwardly by hand, and wherein said catch legs can engage in the catch mechanism when the free ends of the handle side bars are released and allowed to return to their normal separation.

2. The cooking utensil of claim 1 further comprising a stop member on the outside of the side portion of said food container below said catch mechanism to prevent the attachment end of the handle from traveling substantially further past the catch mechanism on the food container once the oppositely extending catch legs at the free ends of the handle side rods are engaged in the catch mechanism.

3. The cooking utensil of claim 1 wherein the catch mechanism on said food container is in the form of a catch loop and wherein the length of said catch loop is approximately the same as the at rest separation of the side rods of said handle.

4. The cooking utensil of claim 1 wherein the oppositely extending catch legs at the opposed free ends of said side rods are formed by outwardly bent ends of the side rods.

5. The cooking utensil of claim 1 wherein said food container is in the form of a bowl.

6. The cooking utensil of claim 1 further comprising at least one open relief slot in the rim of the food container at the location of said catch mechanism, said open relief slot being sized to allow said handle to pivot back into a stowed position over said food container with the oppositely extending catch legs at the free ends of the handle side rods engaged in the catch mechanism of the food container.

7. The cooking utensil of claim 6 wherein said open relief slot is a continuous open slot substantially spanning the catch mechanism.

8. The cooking utensil of claim 7 wherein the catch mechanism of the food container is in the form of a catch loop having a length, and wherein said open relief slot is a continuous slot having a width that substantially spans the length of said catch loop.

9. The cooking utensil of claim 1 wherein said opposed side rods have substantially straight extended portions lying in a plane and wherein said handle has an end portion which is bent down at an angle relative to the plane of the extended portions of said side rods, wherein, when the handle is engaged with the catch mechanism of said food container and is deployed in an extended gripping position, the pitch angle of the handle relative to the food container is decreased.

10. The cooking utensil of claim 8 wherein the angle of the end portion of said handle is bent down at an angle relative to the plane of the extended portions of said side rods at an angle of about 30 degrees.

11. The cooking utensil of claim 1 comprised of multiple food containers of different sizes, wherein each of said food containers has a side portion with an outside, a top rim portion, and a catch mechanism on the outside of the side portion of the food container portion near the top rim portion thereof, and wherein the catch mechanisms for all of the food containers are substantially identical such that the handle of the cooking utensil can engage the catch mechanism of any food container.

12. A cooking utensil comprising
a food container for holding food items, said food container having a side portion and a top rim portion, and said side portion having an outside,
a catch loop on the outside of the side portion of said food container portion at the rim portion thereof,
a handle comprising opposed side rods having opposed free ends and oppositely extending catch legs at the free ends of said side rods wherein said free ends and catch legs form an attachment end of the handle, the opposed free ends of the opposed side rods having a normal at rest separation and being capable of being flexed inwardly towards each other from their normal separation by a pinching force applied by hand to the side rods, wherein the oppositely extending catch legs at the free ends of the handle side rods can be inserted into and disengaged from the catch loop on said food container side portion when the free ends of the opposed side rods are pinched inwardly by hand, and wherein said catch legs can engage in the catch loop when the free ends of the handle side bars are released and allowed to return to their normal separation,
an open relief slot in the rim of the food container at the location of said catch loop, said open relief slot being sized to allow said handle to pivot into a stowed position over said food container with the oppositely extending catch legs at the free ends of the handle side rods engaged in the catch loop of the food container and,
a stop member on the outside of the side portion of said food container below said catch mechanism to prevent the attachment end of the handle from traveling substantially further past the catch loop on the food container once the oppositely extending catch legs at the free ends of the handle side rods are engaged in the catch loop.

13. The cooking utensil of claim 12 wherein said opposed side rods have substantially straight extended portions lying in a plane and wherein said handle has an end portion which is bent down at an angle relative to the plane of the extended portions of said side rods, wherein, when the handle is engaged with the catch loop of said food container and is deployed in an extended gripping position, the pitch angle of the handle relative to the food container is decreased.

14. The cooking utensil of claim 13 wherein the end portion of said handle is bent down at an angle of about 30 degrees relative to the plane of the extended portions of said side rods.

15. The cooking utensil of claim 12 further comprising a slide lock attached across the handle's opposed side rods, wherein, when the catch legs at the free ends of the handle side rods are engaged in the catch loop, said slide lock can be manually slid to a position near the free ends of said opposed side rods to prevent the side rods from being flexed inwardly and disengaged from said catch loop.
